(19) United States
(12) Patent Application Publication
(10) Pub. No.: US 2025/0331086 A1
(43) Pub. Date: Oct. 23, 2025

(54) LIGHTING DEVICE WITH A MICROWAVE MODULE SELF-TEST FUNCTION AND METHOD THEREOF

(71) Applicant: Xiamen PVTECH Co., Ltd., Xiamen (CN)

(72) Inventors: HAO YE, Xiamen (CN); FUXING LU, Xiamen (CN); CHENGQUAN XU, Xiamen (CN)

(73) Assignee: Xiamen PVTECH Co., Ltd., Xiamen (CN)

(21) Appl. No.: 19/172,606

(22) Filed: Apr. 7, 2025

(30) Foreign Application Priority Data
Apr. 18, 2024 (CN) 202410472279.7

(51) Int. Cl. H05B 47/17; G01S 7/40; G01S 13/56; H05B 47/115

(52) U.S. Cl. CPC H05B 47/17; G01S 7/40; G01S 13/56; H05B 47/115

(57) ABSTRACT

A lighting device with a microwave module self-test function includes a control module, a microwave module and a light-emitting module. The microwave module is connected to the control module. The light-emitting module is connected to the control module. The control module executes a self-test mode to adjust the light-emitting module from the current brightness to a test brightness within a preset time interval, detects the number of times the microwave module generates trigger signals within the preset time interval, calculates the sum of the durations of the trigger signals, and generates a detection result according to the number of times and the sum.

### BACKGROUND OF THE INVENTION

### 1. Field of the Invention

The present invention relates to a lighting device, in particular to a lighting device with a microwave module self-test function. The present invention further relates the microwave module self-test method of the lighting device.

### 2. Description of the Prior Art

Lighting devices with moving object detection function have been widely used in various buildings, such as parking lots, office buildings, and factories. The aforementioned moving object detection function is typically implemented via a microwave module (microwave sensor). However, the microwave module may be triggered due to self-excitation caused by various reasons, which may affect the accuracy thereof. For example, the power supply wire of the microwave module is susceptible to interference (such as ripple). For instance, the power amplifier at the final stage of the circuit is prone to interference from radio frequency signals. For example, amplifiers with high gain are likely to be in self-excitation. After the microwave module is triggered by self-excitation, the microwave module internally a high-level signal to the detection pin of the control module of the lighting device, which is identical to the trigger signal generated when the microwave module detects a moving object. This situation may cause the lighting device to suddenly turn on.

### SUMMARY OF THE INVENTION

One embodiment of the present invention provides a lighting device with a microwave module self-test function, which includes a control module, a microwave module and a light-emitting module. The microwave module is connected to the control module. The light-emitting module is connected to the control module. The control module executes a self-test mode to adjust the light-emitting module from the current brightness to a test brightness within a preset time interval, detects the number of times the microwave module generates trigger signals within the preset time interval, calculates the sum of the durations of the trigger signals, and generates a detection result according to the number of times and the sum.

In one embodiment, the lighting device further includes a communication module connected to the control module. The control module executes the self-test mode to turn off the communication module within the preset time interval.

In one embodiment, the control module compares the number of times with a first threshold to generate a first comparison result, compares the sum with a second threshold to generate a second comparison result, and generates the detection result according to the first comparison result and the second comparison result.

In one embodiment, when the first comparison result indicates that the number of times is greater than the first threshold or the second comparison result indicates that the sum is greater than the second threshold, the control module generates the detection result indicating the abnormal state.

In one embodiment, the test brightness is the maximum brightness of the light-emitting module.

Another embodiment of the present invention provides a microwave module self-test method for a lighting device, which includes the following steps: executing a self-test mode to adjust a light-emitting module from the current brightness to a test brightness within a preset time interval by a control module; detecting the number of times a microwave module generates trigger signals within the preset time interval by the control module; calculating the sum of the durations of the trigger signals by the control module; and generating a detection result according to the number of times and the sum by the control module.

In one embodiment, the microwave module self-test method further includes the following step: turning off a communication module within the preset time interval by the control module.

In one embodiment, the step of generating the detection result according to the number of times and the sum by the control module further includes: comparing the number of times with a first threshold to generate a first comparison result by the control module; comparing the sum with a second threshold to generate a second comparison result by the control module; and generating the detection result according to the first comparison result and the second comparison result by the control module.

In one embodiment, the step of generating the detection result according to the number of times and the sum by the control module further includes: generating the detection result indicating the abnormal state when the first comparison result indicates that the number of times is greater than the first threshold or the second comparison result indicates that the sum is greater than the second threshold by the control module.

In one embodiment, the test brightness is the maximum brightness of the light-emitting module.

The lighting device with the microwave module self-test function and method thereof in accordance with the embodiments of the present invention may have the following advantages:
(1) In one embodiment of the present invention, the lighting device with a microwave module self-test function includes a control module, a microwave module and a light-emitting module. The microwave module is connected to the control module. The light-emitting module is connected to the control module. The control module executes a self-test mode to adjust the light-emitting module from the current brightness to a test brightness within a preset time interval, detects the number of times the microwave module generates trigger signals within the preset time interval, calculates the sum of the durations of the trigger signals, and generates a detection result according to the number of times and the sum. The aforementioned microwave module self-test mechanism can be directly executed by the control module of the lighting device without the need for manual detection. Therefore, the aforementioned microwave module self-test mechanism can reduce the manpower costs associated with the maintenance of the lighting device so as to meet actual requirements.
(2) In one embodiment of the present invention, the lighting device has the special microwave module self-test mechanism, which can effectively prevent the lighting device from abnormally turning on due to abnormalities in the microwave module. Therefore, the aforementioned microwave module self-test mechanism can effectively reduce the energy consumption of the lighting device, so the lighting device can be more energy-efficient. Thus, the lighting device can meet environmental protection requirements and align with future development trends.
(3) In one embodiment of the present invention, the lighting device has the special microwave module self-test mechanism, and the aforementioned microwave module self-test mechanism can be directly executed by the control module of the lighting device without the need for manual detection or additional circuit components. Therefore, the aforementioned microwave module self-test mechanism will not increase the manufacturing cost of the lighting device and can achieve the desired function so as to meeting the requirements of different applications.
(4) In one embodiment of the present invention, when the lighting device executes the self-test mode, the control module directly turns off the communication module to prevent triggering other lighting devices. Therefore, the aforementioned microwave module self-test mechanism will not affect the normal operation of other lighting devices in order to make sure that the lighting system can operate normally.
(5) In one embodiment of the present invention, the lighting device further includes a real-time clock module, and the user can adjust the settings of the real-time clock module to change the operating time of the self-test mode. Therefore, the user can set the lighting device to execute the self-test mode at late night or other appropriate times to ensure the normal operation of the lighting system.
(6) In one embodiment of the present invention, the user can directly adjust the settings of the real-time clock module through an application executed on an electronic device (such as a smartphone, tablet, laptop, etc.) to change the operating time of the self-test mode without the assistance of technical personnel. Therefore, the use of the lighting device can be more convenient with a view to meeting the requirements of different applications.
(7) In one embodiment of the present invention, the design of the lighting device is simple, so the lighting device can achieve the desired 1 function without significantly increasing costs. Therefore, the lighting device can achieve high practicality, so the application of the lighting device can be more comprehensive and conform to the requirements of practical applications.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a circuit of a lighting device with a microwave module self-test function in accordance with a first embodiment of the present invention.

FIG. 2 is a block diagram of a circuit of a lighting device with a microwave module self-test function in accordance with a second embodiment of the present invention.

FIG. 3 is a flow chart of a microwave module self-test method for a lighting device in accordance with a third embodiment of the present invention.

FIG. 4 is a flow chart of a microwave module self-test method for a lighting device in accordance with a fourth embodiment of the present invention.

FIG. 5 is a flow chart of a microwave module self-test method for a lighting device in accordance with a fifth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

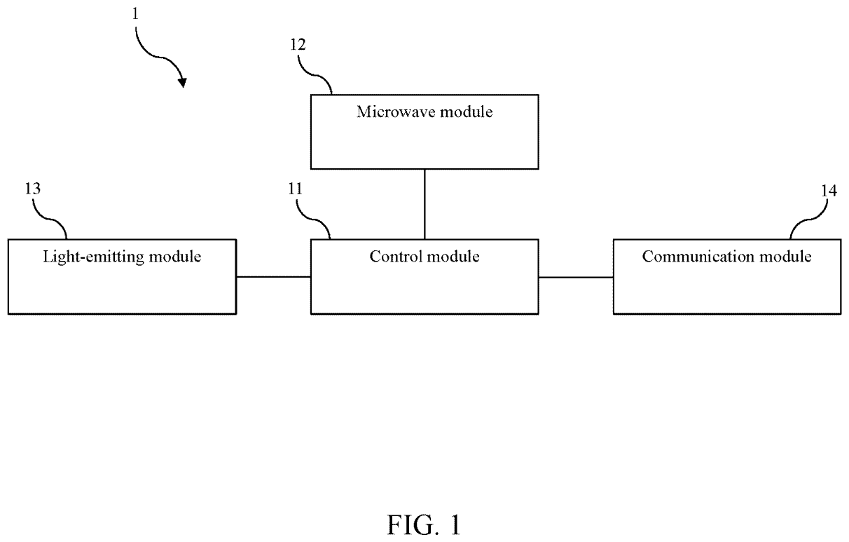

Please refer to FIG. 1, which is a block diagram of a circuit of a lighting device with a microwave module self-test function in accordance with a first embodiment of the present invention. As shown in FIG. 1, the lighting device 1 includes a control module 11, a microwave module 12, a light-emitting module 13, and a communication module 14.

The microwave module 12 is connected to the control module 11. The control module 11 is connected to the microwave module 12 via a detection pin. In one embodiment, the microwave module 12 may be one of various currently available microwave sensors. In another embodiment, the microwave module 12 may be one of various circuits with microwave sensing function. In one embodiment, the control module 11 may be a microcontroller (MCU). In another embodiment, the control module 11 may be a central processing unit (CPU), an application-specific integrated circuit (ASIC), a field-programmable gate array (FPGA), or other similar components.

The light-emitting module 13 is connected to the control module 11. In one embodiment, the light-emitting module 13 may be a light-emitting diode (LED). In another embodiment, the light-emitting module 13 may also be a LED array, a light bulb, a fluorescent lamp, or other currently available light sources.

The communication module 14 is connected to the control module 11. In one embodiment, the communication module 14 may be a Bluetooth module. In another embodiment, the communication module 14 may also be a WiFi module, a ZigBee module, or other similar components.

When the microwave module 12 detects a moving object, the microwave module 12 generates a high-level signal (trigger signal) and transmits the high-level signal to the control module 11. Then, the control module 11 turns on the light-emitting module 13 and simultaneously transmits a start signal to other lighting devices 1 via the communication module 14 to activate the other lighting devices 1. When the microwave module 12 is triggered by self-excitation, the microwave module 12 also generates a high-level signal (identical to the trigger signal) and transmits the high-level signal to the control module 11.

The control module 11 can execute a self-test mode. In the self-test mode, the control module 11 adjusts the light-emitting module 13 from the current brightness to a test brightness within a preset time interval. The control module 11 turns off the communication module 14 to keep the communication module 14 in the off state during the preset time interval. The aforementioned preset time interval can be adjusted according to actual needs. For example, the aforementioned preset time interval may be half an hour, 1 hour, or 2 hours, but is not limited to these values. The aforementioned test brightness may be the maximum brightness of the light-emitting module 13, but is not limited to this. When the brightness of the light-emitting module 13 reaches the maximum thereof, the noise of the lighting device 1 is highest, making the microwave module 12 prone to suffer from self-excitation.

Then, in the self-test mode, the control module 11 detects the number of times the microwave module 12 generates the trigger signals within the preset time interval and calculates the sum of the durations of the trigger signals. Then, the control module 11 generates a detection result according to the aforementioned number of times and the aforementioned sum. Specifically, the control module 11 compares the aforementioned number of times with a first threshold to generate a first comparison result and compares the aforementioned sum with a second threshold to generate a second comparison result. Then, the control module 11 generates a detection result according to the first comparison result and the second comparison result. When the first comparison result indicates that the aforementioned number of times is greater than the first threshold or the second comparison result indicates that the aforementioned sum is greater than the second threshold, the control module 11 generates a detection result indicating the abnormal state and transmits the detection to the user's electronic device. Then, the control module 11 turns off the control module 11, the microwave module 12, the light-emitting module 13, and the communication module 14. At this time, the lighting device 1 does not participate in the operation of the lighting system, and the user can take necessary measures (such as repairing the lighting device 1). In this embodiment, the first threshold may be 1, and the second threshold may be 60 seconds. In another embodiment, the first threshold may be 2, and the second threshold may be 120 seconds. The aforementioned first threshold and second threshold can be adjusted according to actual needs.

As set forth above, the aforementioned microwave module self-test mechanism can be directly executed by the control module 11 of the lighting device 1 without the need for manual detection. Therefore,, the aforementioned microwave module 12 self-test mechanism can reduce the labor costs associated with the maintenance of the lighting device 1 so as to meet actual requirements.

Additionally, in this embodiment, the lighting device 1 has the special microwave module self-test mechanism, which can effectively prevent the lighting device 1 from abnormally turning on due to abnormalities in the microwave module 12. Therefore, the aforementioned microwave module self-test mechanism can effectively reduce the energy consumption of the lighting device 1, so the lighting device 1 can be more energy-efficient. Thus, the lighting device 1 can meet environmental protection requirements and align with future development trends.

Furthermore, in this embodiment, the lighting device 1 has the special microwave module self-test mechanism, and the aforementioned microwave module self-test mechanism can be directly executed by the control module 11 of the lighting device 1 without the need for manual detection or additional circuit components. Therefore, the aforementioned microwave module self-test mechanism will not increase the manufacturing cost of the lighting device 1 and can achieve the desired function with a view to meeting the needs of different applications.

The embodiment just exemplifies the present invention and is not intended to limit the scope of the present invention; any equivalent modification and variation according to the spirit of the present invention is to be also included within the scope of the following claims and their equivalents.

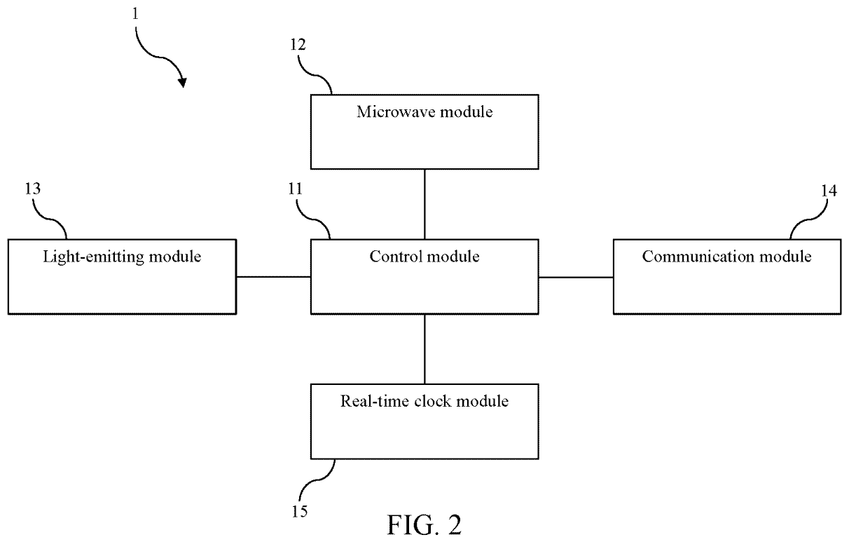

Please refer to FIG. 2, which is a block diagram of a circuit of a lighting device with a microwave module self-test function in accordance with a second embodiment of the present invention. As shown in FIG. 2, the lighting device 1 includes a control module 11, a microwave module 12, a light-emitting module 13, and a communication module 14.

The microwave module 12 is connected to the control module 11. The control module 11 is connected to the microwave module 12 through a detection pin. The light-emitting module 13 is connected to the control module 11. The communication module 14 is connected to the control module 11.

The difference between this embodiment and the previous embodiment is that the lighting device 1, in this embodiment, further includes a real-time clock (RTC) module 15. The user can adjust the settings of the real-time clock module 15 to change the operating time of the self-test mode. Therefore, the user can set the lighting device 1 to execute the self-test mode at late night or other appropriate times to ensure the normal operation of the lighting system.

The user can directly adjust the settings of the real-time clock module 15 through an application executed on an electronic device (such as a smartphone, tablet, laptop, etc.) to change the operating time of the self-test mode without the assistance of technical personnel. Therefore, the use of the lighting device 1 can be more convenient, which can conform to the requirements of different applications. Additionally, the user can also adjust the preset time interval, the first threshold, or the second threshold via the electronic device.

The embodiment just exemplifies the present invention and is not intended to limit the scope of the present invention; any equivalent modification and variation according to the spirit of the present invention is to be also included within the scope of the following claims and their equivalents.

It is worthy to point out that the microwave module may be triggered due to self-excitation caused by various reasons, which may affect the accuracy thereof. For example, the power supply wire of the microwave module is susceptible to interference (such as ripple). For instance, the power amplifier at the final stage of the circuit is prone to interference from radio frequency signals. For example, amplifiers with high gain are likely to be in self-excitation. After the microwave module is triggered by self-excitation, the microwave module internally a high-level signal to the detection pin of the control module of the lighting device, which is identical to the trigger signal generated when the microwave module detects a moving object. This situation may cause the lighting device to suddenly turn on. By contrast, according to one embodiment of the present invention, the lighting device with a microwave module self-test function includes a control module, a microwave module and a light-emitting module. The microwave module is connected to the control module. The light-emitting module is connected to the control module. The control module executes a self-test mode to adjust the light-emitting module from the current brightness to a test brightness within a preset time interval, detects the number of times the microwave module generates trigger signals within the preset time interval, calculates the sum of the durations of the trigger signals, and generates a detection result according to the number of times and the sum. The aforementioned microwave module self-test mechanism can be directly executed by the control module of the lighting device without the need for manual detection. Therefore, the aforementioned microwave module self-test mechanism can reduce the manpower costs associated with the maintenance of the lighting device so as to meet actual requirements.

According to one embodiment of the present invention, the lighting device has the special microwave module self-test mechanism, which can effectively prevent the lighting device from abnormally turning on due to abnormalities in the microwave module. Therefore, the aforementioned microwave module self-test mechanism can effectively reduce the energy consumption of the lighting device, so the lighting device can be more energy-efficient. Thus, the lighting device can meet environmental protection requirements and align with future development trends.

According to one embodiment of the present invention, the lighting device has the special microwave module self-test mechanism, and the aforementioned microwave module self-test mechanism can be directly executed by the control module of the lighting device without the need for manual detection or additional circuit components. Therefore, the aforementioned microwave module self-test mechanism will not increase the manufacturing cost of the lighting device and can achieve the desired function so as to meeting the requirements of different applications.

Also, according to one embodiment of the present invention, when the lighting device executes the self-test mode, the control module directly turns off the communication module to prevent triggering other lighting devices. Therefore, the aforementioned microwave module self-test mechanism will not affect the normal operation of other lighting devices in order to make sure that the lighting system can operate normally.

Further, according to one embodiment of the present invention, the lighting device further includes a real-time clock module, and the user can adjust the settings of the real-time clock module to change the operating time of the self-test mode. Therefore, the user can set the lighting device to execute the self-test mode at late night or other appropriate times to ensure the normal operation of the lighting system.

Moreover, according to one embodiment of the present invention, the user can directly adjust the settings of the real-time clock module through an application executed on an electronic device (such as a smartphone, tablet, laptop, etc.) to change the operating time of the self-test mode without the assistance of technical personnel. Therefore, the use of the lighting device can be more convenient with a view to meeting the requirements of different applications.

Furthermore, according to one embodiment of the present invention, the design of the lighting device is simple, so the lighting device can achieve the desired function without significantly increasing costs. Therefore, the lighting device can achieve high practicality, so the application of the lighting device can be more comprehensive and conform to the requirements of practical applications. As described above, the lighting device with the microwave module self-test function can achieve great technical effects.

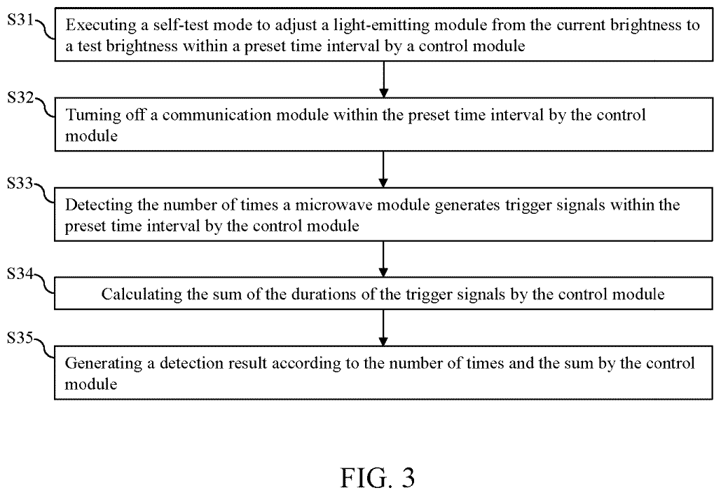

Please refer to FIG. 3, which is a flow chart of a microwave module self-test method for a lighting device in accordance with a third embodiment of the present invention. As shown in FIG. 3, the microwave module self-test method of this embodiment includes the following steps:
Step S31: executing a self-test mode to adjust a light-emitting module from the current brightness to a test brightness within a preset time interval by a control module.
Step S32: turning off a communication module within the preset time interval by the control module.
Step S33: detecting the number of times a microwave module generates trigger signals within the preset time interval by the control module.
Step S34: calculating the sum of the durations of the trigger signals by the control module.
Step S35: generating a detection result according to the number of times and the sum by the control module.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

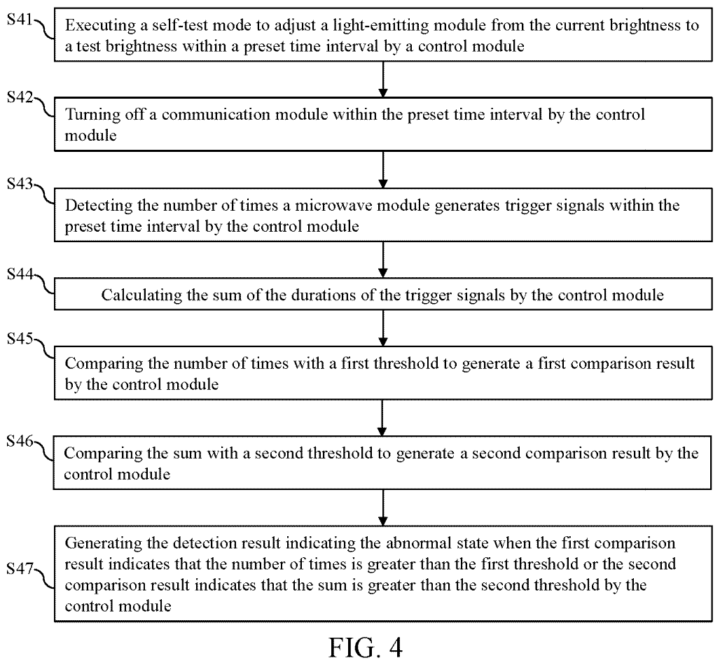

Please refer to FIG. 4, which is a flow chart of a microwave module self-test method for a lighting device in accordance with a fourth embodiment of the present invention. As shown in FIG. 4, the microwave module self-test method of this embodiment includes the following steps:
Step S41: executing a self-test mode to adjust a light-emitting module from the current brightness to a test brightness within a preset time interval by a control module.
Step S42: turning off a communication module within the preset time interval by the control module.
Step S43: detecting the number of times a microwave module generates trigger signals within the preset time interval by the control module.
Step S44: calculating the sum of the durations of the trigger signals by the control module.
Step S45: comparing the number of times with a first threshold to generate a first comparison result by the control module.
Step S46: comparing the sum with a second threshold to generate a second comparison result by the control module.
Step S47: generating the detection result indicating the abnormal state when the first comparison result indicates that the number of times is greater than the first threshold or the second comparison result indicates that the sum is greater than the second threshold by the control module.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

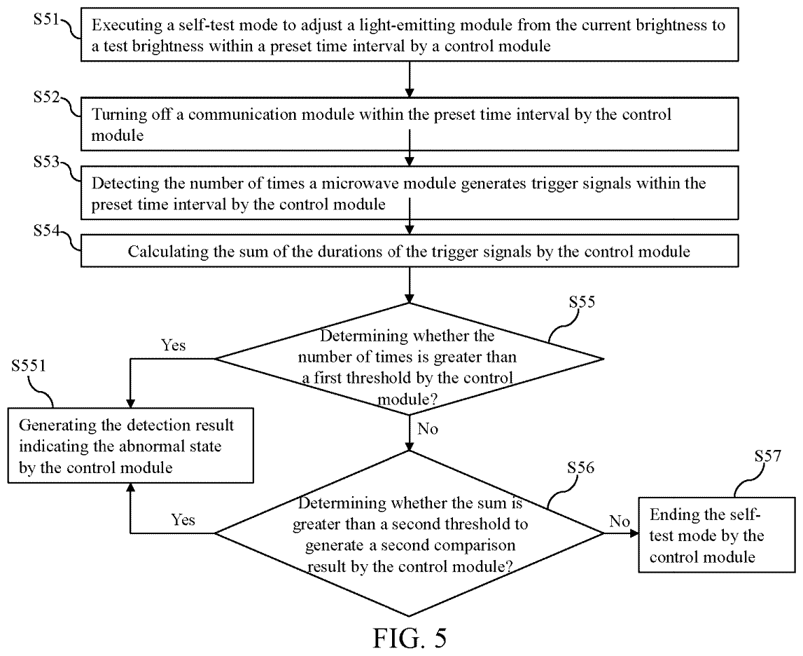

FIG. 5 is a flow chart of a microwave module self-test method for a lighting device in accordance with a fifth embodiment of the present invention.
Step S51: executing a self-test mode to adjust a light-emitting module from the current brightness to a test brightness within a preset time interval by a control module.
Step S52: turning off a communication module within the preset time interval by the control module.
Step S53: detecting the number of times a microwave module generates trigger signals within the preset time interval by the control module.
Step S54: calculating the sum of the durations of the trigger signals by the control module.
Step S55: determining whether the number of times is greater than a first threshold by the control module? if it is, the process proceeds to Step S551; if it is not, the process proceeds to Step S56.
Step S56: determining whether the sum is greater than a second threshold to generate a second comparison result by the control module? if it is, the process proceeds to Step S551; if it is not, the process proceeds to Step S57.
S551: generating the detection result indicating the abnormal state by the control module.
Step S57: ending the self-test mode by the control module. Then, the lighting device can return to the normal operating state.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the lighting device with a microwave module self-test function includes a control module, a microwave module and a light-emitting module. The microwave module is connected to the control module. The light-emitting module is connected to the control module. The control module executes a self-test mode to adjust the light-emitting module from the current brightness to a test brightness within a preset time interval, detects the number of times the microwave module generates trigger signals within the preset time interval, calculates the sum of the durations of the trigger signals, and generates a detection result according to the number of times and the sum. The aforementioned microwave module self-test mechanism can be directly executed by the control module of the lighting device without the need for manual detection. Therefore, the aforementioned microwave module self-test mechanism can reduce the manpower costs associated with the maintenance of the lighting device so as to meet actual requirements.

According to one embodiment of the present invention, the lighting device has the special microwave module self-test mechanism, which can effectively prevent the lighting device from abnormally turning on due to abnormalities in the microwave module. Therefore, the aforementioned microwave module mechanism can effectively reduce the energy consumption of the lighting device, so the lighting device can be more energy-efficient. Thus, the lighting device can meet environmental protection requirements and align with future development trends.

According to one embodiment of the present invention, the lighting device has the special microwave module self-test mechanism, and the aforementioned microwave module self-test mechanism can be directly executed by the control module of the lighting device without the need for manual detection or additional circuit components. Therefore, the aforementioned microwave module self-test mechanism will not increase the manufacturing cost of the lighting device and can achieve the desired function so as to meeting the requirements of different applications.

Also, according to one embodiment of the present invention, when the lighting device executes the self-test mode, the control module directly turns off the communication module to prevent triggering other lighting devices. Therefore, the aforementioned microwave module self-test mechanism will not affect the normal operation of other lighting devices in order to make sure that the lighting system can operate normally.

Further, according to one embodiment of the present invention, the lighting device further includes a real-time clock module, and the user can adjust the settings of the real-time clock module to change the operating time of the self-test mode. Therefore, the user can set the lighting device to execute the self-test mode at late night or other appropriate times to ensure the normal operation of the lighting system.

Moreover, according to one embodiment of the present invention, the user can directly adjust the settings of the real-time clock module through an application executed on an electronic device (such as a smartphone, tablet, laptop, etc.) to change the operating time of the self-test mode without the assistance of technical personnel. Therefore, the use of the lighting device can be more convenient with a view to meeting the requirements of different applications.

Furthermore, according to one embodiment of the present invention, the design of the lighting device is simple, so the lighting device can achieve the desired function without significantly increasing costs. Therefore, the lighting device can achieve high practicality, so the application of the lighting device can be more comprehensive and conform to the requirements of practical applications.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device with a microwave module self-test function, comprising:
a control module;
a microwave module connected to the control module; and
a light-emitting module connected to the control module;
wherein the control module is configured to execute a self-test mode to adjust the light-emitting module from a current brightness to a test brightness within a preset time interval, detect a number of times the microwave module generates trigger signals within the preset time interval, calculate a sum of durations of the trigger signals, and generate a detection result according to the number of times and the sum.

2. The lighting device with the microwave module self-test function as claimed in claim 1, further comprising a communication module connected to the control module, wherein the control module is configured to execute the self-test mode to turn off the communication module within the preset time interval.

3. The lighting device with the microwave module self-test function as claimed in claim 1, wherein the control module is configured to compare the number of times with a first threshold to generate a first comparison result, compare the sum with a second threshold to generate a second comparison result, and generate the detection result according to the first comparison result and the second comparison result.

4. The lighting device with the microwave module self-test function as claimed in claim 3, wherein when the first comparison result indicates that the number of times is greater than the first threshold or the second comparison result indicates that the sum is greater than the second threshold, the control module is configured to generate the detection result indicating an abnormal state.

5. The lighting device with the microwave module self-test function as claimed in claim 1, wherein the test brightness is a maximum brightness of the light-emitting module.

6. A microwave module self-test method for a lighting device, comprising:
executing a self-test mode to adjust a light-emitting module from a current brightness to a test brightness within a preset time interval by a control module;
detecting a number of times a microwave module generates trigger signals within the preset time interval by the control module;
calculating a sum of durations of the trigger signals by the control module; and
generating a detection result according to the number of times and the sum by the control module.

7. The microwave module self-test method for the lighting device as claimed in claim 6, further comprising:
turning off a communication module within the preset time interval by the control module.

8. The microwave module self-test method for the lighting device as claimed in claim 6, wherein a step of generating the detection result according to the number of times and the sum by the control module further comprises:
comparing the number of times with a first threshold to generate a first comparison result by the control module;
comparing the sum with a second threshold to generate a second comparison result by the control module; and
generating the detection result according to the first comparison result and the second comparison result by the control module.

9. The microwave module self-test method for the lighting device as claimed in claim 8, wherein the step of generating the detection result according to the number of times and the sum by the control module further comprises:
generating the detection result indicating an abnormal state when the first comparison result indicates that the number of times is greater than the first threshold or the second comparison result indicates that the sum is greater than the second threshold by the control module.

10. The microwave module self-test method for the lighting device as claimed in claim 6, wherein the test brightness is a maximum brightness of the light-emitting module.
